(19) United States
(12) Patent Application Publication
(10) Pub. No.: US 2026/0274359 A1
(43) Pub. Date: Sep. 17, 2026

(54) CONTROL SYSTEM

(71) Applicant: TOYOTA JIDOSHA KABUSHIKI KAISHA, Toyota-shi (JP)

(72) Inventors: Kazuhiko UEDA, Tokyo (JP); Takeshi KANOU, Seto-shi (JP); Satoshi TAKAHASHI, Yokohama-shi (JP); Kento IWAHORI, Nagoya-shi (JP)

(73) Assignee: TOYOTA JIDOSHA KABUSHIKI KAISHA, Toyota-shi (JP)

(21) Appl. No.: 19/442,281

(22) Filed: Jan. 7, 2026

(30) Foreign Application Priority Data
Mar. 14, 2025 (JP) 2025-040889

(51) Int. Cl. B62D 65/16; G05D 1/639; G05D 1/646; G05D 107/70

(52) U.S. Cl. CPC B62D 65/16; G05D 1/639; G05D 1/646; G05D 2107/70

(57) ABSTRACT

A control system that controls a vehicle capable of traveling under unmanned driving includes: an acquisition unit that acquires step information related to a specific step that is predetermined as a step to be crossed by the vehicle among steps present on a traveling path of the vehicle; a detection unit that detects that the specific step is present ahead of the vehicle traveling by using the step information; and a controller that increases a driving torque of the vehicle in a case where the detection unit detects that the specific step is present ahead of the vehicle traveling.

### CROSS-REFERENCE TO RELATED APPLICATION

This application claims priority to Japanese Patent Application No. 2025-040889 filed on Mar. 14, 2025. The disclosure of the above-identified application, including the specification, drawings, and claims, is incorporated by reference herein in its entirety.

### BACKGROUND

### 1. Technical Field

The present disclosure relates to a control system.

### 2. Description of Related Art

A technique of causing a vehicle to travel under unmanned driving in a factory that manufactures a vehicle is known (Japanese Unexamined Patent Application Publication No. 2017-538619 (JP 2017-538619 A)).

### SUMMARY

In a case where a step to be ridden over by the vehicle is present on a travel route of the vehicle, in a case where driving torque of the vehicle is maintained without being changed from when the vehicle is traveling other than over the step, the vehicle may not be able to ride over the step.

The present disclosure can be implemented as the following aspects.

(1) According to an aspect of the present disclosure, a control system is provided.

The control system for controlling a vehicle configured to travel under unmanned driving includes

an acquisition unit configured to acquire step information related to a specific step that is predetermined as a step to be ridden over by the vehicle among steps present on a travel route of the vehicle,

a detection unit configured to detect, using the step information, that the specific step is present ahead of the vehicle as the vehicle travels, and

a controller configured to increase driving torque of the vehicle in a case where the detection unit detects that the specific step is present ahead of the vehicle as the vehicle travels.

According to this aspect, the control system can increase the driving torque of the vehicle in a case where the specific step is detected to be present ahead of the vehicle as the vehicle travels. As a result, the vehicle can be made to ride over the specific step.

(2) According to the aspect,

the step information may include object position information indicating a position of an object that causes the specific step,

the acquisition unit may be further configured to acquire vehicle position information indicating a position of the vehicle, and

the detection unit may be configured to detect that the specific step is present ahead of the vehicle as the vehicle travels in a case where a distance between the object and the vehicle is within a predetermined distance, the distance being specified by using the object position information and the vehicle position information.

According to this aspect, it is possible to detect, based on the distance between the object that causes the specific step and the vehicle, that the specific step is present ahead of the vehicle as the vehicle travels.

(3) According to the aspect,

the step information may include step process information indicating a work process executed at a workplace where the specific step is present,

the acquisition unit may be further configured to acquire execution process information indicating the work process that is being executed on the vehicle, and

the detection unit may be configured to detect that the specific step is present ahead of the vehicle as the vehicle travels in a case where the work process specified by the execution process information matches the work process specified by the step process information.

According to this aspect, it is possible to detect that the vehicle is approaching the specific step by using the fact that the work process in which the object that causes the specific step is present is known.

(4) According to the aspect,

the acquisition unit may be further configured to acquire information related to a size of the

specific step, and

the controller may be configured to determine an amount of increase in the driving torque based on the size of the specific step.

According to this aspect, it is possible to determine the amount of increase in the driving torque based on the size of the specific step. As a result, the vehicle can be more reliably made to ride over the specific step. In addition, it is possible to inhibit the driving torque of the vehicle from being increased more than necessary in a case where the vehicle rides over the specific step.

(5) According to the aspect,

the acquisition unit may be further configured to acquire information related to a shape of the specific step, and

the controller may be configured to determine an amount of increase in the driving torque based on the shape of the specific step.

According to this aspect, it is possible to determine the amount of increase in the driving torque based on the shape of the specific step. As a result, the vehicle can be more reliably made to ride over the specific step. In addition, it is possible to inhibit the driving torque of the vehicle from being increased more than necessary in a case where the vehicle rides over the specific step.

The present disclosure can be implemented in various aspects other than the control system. For example, the present disclosure can be implemented in aspects such as a vehicle or a server that can realize at least a part of a function of the control system, a method of controlling the vehicle by the control system. Further, the present disclosure can be implemented in aspects such as a computer program that implements the control method, and a non-transitory recording medium on which the computer program is recorded.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a configuration of a control system in a first embodiment;

FIG. 2 is a block diagram showing a configuration of the control system in the first embodiment;

FIG. 3 is a flowchart showing a processing procedure of traveling control for a vehicle according to the first embodiment;

FIG. 4 is a flowchart showing a control method in the first embodiment;

FIG. 5 is a block diagram showing a configuration of a control system in a second embodiment;

FIG. 6 is a flowchart showing a control method in the second embodiment;

FIG. 7 is an explanatory diagram showing a schematic configuration of a control system in a third embodiment; and

FIG. 8 is a flowchart showing a processing procedure of traveling control for a vehicle according to the third embodiment.

### DETAILED DESCRIPTION OF EMBODIMENTS

### A. First Embodiment

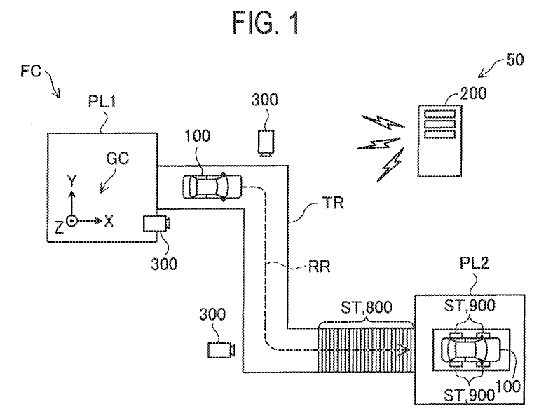

FIG. 1 is a conceptual diagram showing a configuration of a control system 50 according to a first embodiment. The control system 50 comprises one or more vehicles 100, a server 200, and one or more external sensors 300.

The vehicle may be a vehicle that travels using wheels or a vehicle that travels using a caterpillar, and is, for example, a passenger car, a truck, a bus, a two-wheeled vehicle, a four-wheeled vehicle, and a construction vehicle. The vehicle includes a battery electric vehicle (BEV), a gasoline vehicle, a hybrid electric vehicle, and a fuel cell electric vehicle.

The vehicle 100 is configured to travel under unmanned driving. The “unmanned driving” means driving that does not depend on a traveling operation of an occupant. The traveling operation means an operation related to at least any one of “traveling”, “turning”, and “stopping” of the vehicle 100. The unmanned driving is implemented by automatic or manual remote control using a device located outside the vehicle 100 or by autonomous control of the vehicle 100. The occupant who does not perform the traveling operation may get on the vehicle 100 that travels under the unmanned driving. Examples of the occupant who does not perform the traveling operation include a

person who simply sits on a seat of the vehicle 100 and a person who performs work different from the traveling operation, such as assembly, inspection, or operation of switches, in a state of getting on the vehicle 100. The driving via the traveling operation performed by the occupant may be referred to as “manned driving”.

In the present specification, the “remote control” includes “complete remote control” in which all the operations of the vehicle 100 are completely decided from the outside of the vehicle 100, and “partial remote control” in which a part of the operations of the vehicle 100 is decided from the outside of the vehicle 100. In addition, the “autonomous control” includes “full autonomous control” and “partial autonomous control”. In the “full autonomous control”, the vehicle 100 autonomously controls its own operation without receiving any information from a device outside the vehicle 100. In the “partial autonomous control”, the vehicle 100 autonomously controls its own operation by using information received from a device outside the vehicle 100.

In the present embodiment, the control system 50 is used in a factory FC that manufactures the vehicle 100 by executing a plurality of manufacturing processes. A reference coordinate system of the factory FC is a global coordinate system GC, and any position in the factory FC can be expressed by coordinates of X, Y, and Z in the global coordinate system GC. The factory FC includes a first place PL1 and a second place PL2. In each of the first place PL1 and the second place PL2, for example, one or more actual processes such as an assembly process or an inspection process are executed among a plurality of manufacturing processes. The first place PL1 and the second place PL2 are connected by a track TR on which the vehicle 100 can travel. The vehicle 100 moves under the unmanned driving from the first place PL1 to the second place PL2 along the track TR. On the track TR, for example, a transport process of transporting the vehicle 100 from the first place PL1 to the second place PL2 is executed among a plurality of manufacturing processes. The configuration of the factory FC is not limited to the above.

A plurality of external sensors 300 is installed in the factory FC along the track TR. A position of each external sensor 300 in the factory FC is adjusted in advance. The external sensor 300 is a sensor located outside the vehicle 100. The external sensor 300 according to the present embodiment is a sensor that captures the vehicle 100 from the outside of the vehicle 100. The external sensor 300 includes a communication device (not shown), and can communicate with other devices, such as the server 200, via wired communication or wireless communication. Specifically, the external sensor 300 is configured by a camera. The camera as the external sensor 300 images the vehicle 100 and outputs a captured image as the detection result.

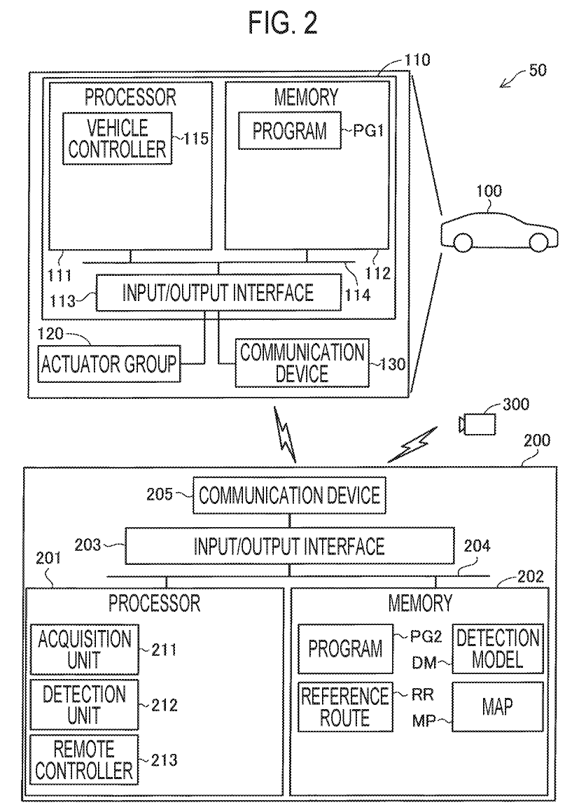

FIG. 2 is a block diagram showing a configuration of a control system 50 according to a first embodiment. The vehicle 100 comprises a vehicle control device 110 for controlling each unit of the vehicle 100. Further, the vehicle 100 comprises an actuator group 120 including one or more actuators that are driven under the control of the vehicle control device 110, and a communication device 130 for communicating with an external device such as the server 200 by wireless communication. The actuator group 120 includes an actuator of a drive device for accelerating the vehicle 100, an actuator of a steering device for changing a traveling direction of the vehicle 100, and an actuator of a braking device for decelerating the vehicle 100.

The vehicle control device 110 is configured by a computer including a processor 111, a memory 112, an input/output interface 113, and an internal bus 114. The processor 111, the memory 112, and the input/output interface 113 are connected to be bidirectionally communicable with each other via the internal bus 114. The actuator group 120 and the communication device 130 are connected to the input/output interface 113. The processor 111 executes a program PG1 stored in the memory 112 to implement various functions including functions as a vehicle controller 115.

The vehicle controller 115 controls the actuator group 120 to cause the vehicle 100 to travel. The vehicle controller 115 can cause the vehicle 100 to travel by controlling the actuator group 120 using a traveling control signal received from the server 200. The traveling control signal is a control signal for causing the vehicle 100 to travel. In the present embodiment, the traveling control signal includes the acceleration and a steering angle of the vehicle 100 as parameters. In other embodiments, the traveling control signal may include a speed of the vehicle 100 as the parameter instead of or in addition to the acceleration of the vehicle 100. Further, the vehicle controller 115 can change the driving torque of the vehicle 100 by controlling the actuator group 120 by using the control signal received from the server 200.

The server 200 is configured by a computer including a processor 201, a memory 202, an input/output interface 203, and an internal bus 204. The processor 201, the memory 202, and the input/output interface 203 are connected to be bidirectionally communicable with each other via the internal bus 204. A communication device 205 for communicating with various devices outside the server 200 is connected to the input/output interface 203. The communication device 205 can communicate with the vehicle 100 via wireless communication, and can communicate with each external sensor 300 via wired communication or wireless communication. The processor 201 executes a program PG2 stored in the memory 202 to implement various functions including a function as an acquisition unit 211, a detection unit 212, and a remote controller 213.

The acquisition unit 211 acquires various types of information including the step information. The step information is information related to a specific step ST that is predetermined as a step to be crossed by the vehicle 100 among steps present on the traveling path of the vehicle 100. The specific step ST is, for example, a step caused by an object installed at a manufacturing place PL1, PL2, TR where the manufacturing process is executed on the vehicle 100. The object that causes the specific step ST may be any of a fixed object fixed to a road surface or a portable movable object that can appropriately change a disposition on the road surface. As shown in FIG. 1, the object that causes the specific step ST is, for example, a transport equipment 800 such as a slat conveyor installed on the track TR. In this case, the specific step ST is a step that occurs at a boundary between the road surface and the transport equipment 800. In addition, the object that causes the specific step ST may be an inspection equipment 900 such as a drum tester or a brake tester roller installed at the second place PL2. In this case, the specific step ST is a step that occurs at a boundary between the road surface and the inspection equipment 900. The specific step ST is not limited to the above.

In the present embodiment, the acquisition unit 211 shown in FIG. 2 acquires the step information including the object position information indicating the position of the object that causes the specific step ST and the vehicle position information indicating the position of the vehicle 100. The acquisition unit 211 acquires the object position information by referring to, for example, a map MP stored in advance in the memory 202, the map MP representing the position of each object in the factory FC by the global coordinate system GC. In addition, the acquisition unit 211 acquires the vehicle position information by using, for example, the detection result of the external sensor 300. The acquisition unit 211 may acquire the object position information by using the detection result of the external sensor 300, or may acquire the object position information or the vehicle position information by using the detection result of an internal sensor mounted on the vehicle 100.

The detection unit 212 detects that the specific step ST is present ahead of the vehicle 100 that has moved forward or backward, that is, ahead of the vehicle 100 that has traveled, by using the step information. In the present embodiment, the detection unit 212 specifies a distance between the object that causes the specific step ST and the vehicle 100 by using the object position information and the vehicle position information. In a case where the specified distance is within a predetermined distance, the detection unit 212 detects that the specific step ST is present ahead of the vehicle 100 that has traveled.

The remote controller 213 acquires the detection result of the sensor and generates the traveling control signal for controlling the actuator group 120 of the vehicle 100 by using the detection result. The remote controller 213 causes the vehicle 100 to travel by sending the traveling control signal to the vehicle 100 by the remote control. During the period in which the remote control is executed, the detection unit 212 may detect that the specific step ST is present ahead of the vehicle 100 that has traveled. In such a case, the remote controller 213 increases the driving torque of the vehicle 100 to a degree at which the vehicle 100 can cross the specific step ST. The detection unit 212 may detect that the specific step ST is present ahead of the vehicle 100 that has traveled. In such a case, in a case where the maximum allowable torque is predetermined, the remote controller 213 may temporarily increase the maximum allowable torque or may temporarily release the restriction by the maximum allowable torque. The maximum allowable torque is a maximum value of the allowable driving torque.

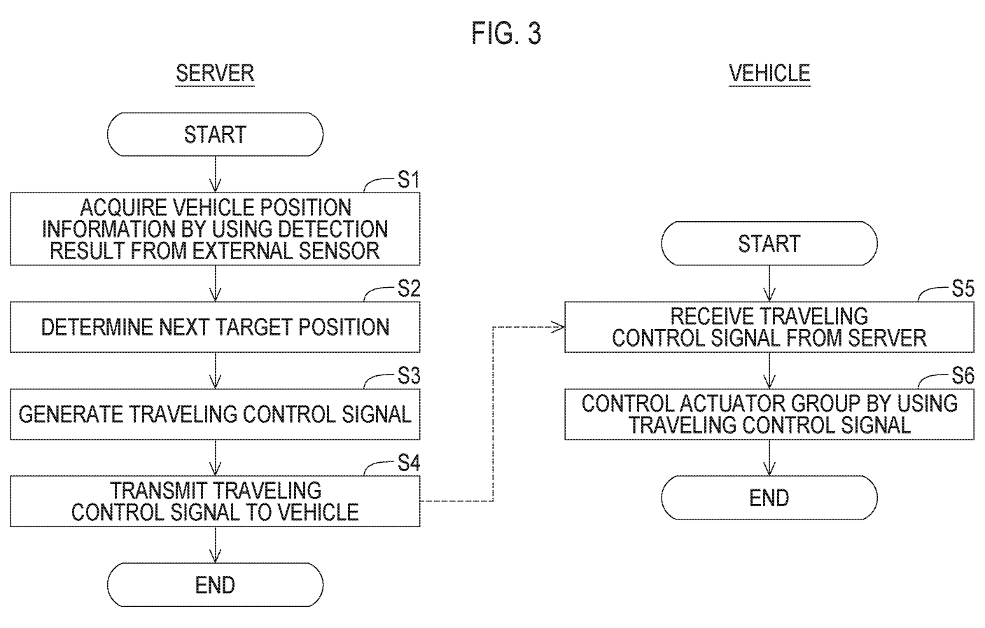

FIG. 3 is a flowchart showing the processing procedure of the traveling control of the vehicle 100 according to the first embodiment. In the processing procedure of FIG. 3, the processor 201 of the server 200 executes the program PG2 to function as the remote controller 213. In addition, the processor 111 of the vehicle 100 executes the program PG1 to function as the vehicle controller 115.

In step S1, the processor 201 of the server 200 acquires the vehicle position information by using the detection result output from the external sensor 300. The vehicle position information is position information that is a basis for generating the traveling control signal. In the present embodiment, the vehicle position information includes the position and the direction of the vehicle 100 in the global coordinate system GC of the factory FC. Specifically, in step S1, the processor 201 acquires the vehicle position information by using the captured image acquired from the camera as the external sensor 300.

Specifically, in step S1, the processor 201 detects, for example, an external shape of the vehicle 100 from the captured image. Then, the processor 201 calculates coordinates of a positioning point of the vehicle 100 in a coordinate system of the captured image, that is, a local coordinate system. Then, the processor 201 acquires the position of the vehicle 100 by converting the calculated coordinates into coordinates in the global coordinate system GC. The outer shape of the vehicle 100 included in the captured image can be detected, for example, by inputting the captured image to a detection model DM using artificial intelligence. The detection model DM is prepared inside the control system 50 or outside the control system 50, and is stored in advance in the memory 202 of the server 200. Examples of the detection model DM include a trained machine learning model that has been trained to implement any one of semantic segmentation and instance segmentation. As the machine learning model, for example, a convolutional neural network (CNN) that has been trained by supervised learning using a training data set can be used. The training data set has, for example, a plurality of training images including the vehicle 100 and a label indicating whether each area in the training image is an area indicating the vehicle 100 or an area indicating an area other than the vehicle 100. When the CNN is trained, it is preferable that parameters of the CNN are updated such that an error between an output result of the detection model DM and the label is reduced by backpropagation (error backpropagation method). In addition, the processor 201 estimates, for example, the orientation of the movement vector of the vehicle 100 calculated from the positional change of the feature point of the vehicle 100 between frames of the captured image by using an optical flow method. The processor 201 can acquire the orientation of the vehicle 100 by doing so.

In step S2, the processor 201 of the server 200 determines a target position to which the vehicle 100 is to travel next. In the present embodiment, the target position is represented by the coordinates of X, Y, and Z in the global coordinate system GC. A reference route RR that is a route along which the vehicle 100 should travel is stored in advance in the memory 202 of the server 200. The route is represented by a node indicating a departure point, a node indicating a passing point, a node indicating a destination, and a link connecting the respective nodes. The processor 201 decides the target position to which the vehicle 100 should head next by using the vehicle position information and the reference route RR. The processor 201 decides the target position on the reference route RR ahead of the current position of the vehicle 100.

In step S3, the processor 201 of the server 200 generates the traveling control signal for causing the vehicle 100 to travel toward the decided target position. The processor 201 calculates the traveling speed of the vehicle 100 from the transition of the position of the vehicle 100, and compares the calculated traveling speed with a target speed. As a whole, the processor 201 decides the acceleration such that the vehicle 100 is accelerated when the traveling speed is lower than the target speed, and decides the acceleration such that the vehicle 100 is decelerated when the traveling speed is higher than the target speed. In addition, the processor 201 determines the steering angle and the acceleration such that the vehicle 100 does not deviate from the reference route RR in a case where the vehicle 100 is positioned on the reference route RR. In a case where the vehicle 100 is not located on the reference route RR, in other words, in a case where the vehicle 100 deviates from the reference route RR, the processor 201 decides the steering angle and the acceleration such that the vehicle 100 returns to the reference route RR.

In step S4, the processor 201 of the server 200 transmits the generated traveling control signal to the vehicle 100. The processor 201 repeatedly executes, at a predetermined cycle, the acquisition of the vehicle position information, the decision of the target position, the generation of the traveling control signal, and the transmission of the traveling control signal.

In step S5, the processor 111 of the vehicle 100 receives the traveling control signal transmitted from the server 200. In step S6, the processor 111 of the vehicle 100 controls the actuator group 120 by using the received traveling control signal, to cause the vehicle 100 to travel at the acceleration and the steering angle represented by the traveling control signal. The processor 111 repeatedly executes, at a predetermined cycle, the reception of the traveling control signal and control of the actuator group 120. With the control system 50 according to the present embodiment, the vehicle 100 can be caused to travel via the remote control, and the vehicle 100 can be caused to move without using transport equipment 800, such as a crane or a conveyor.

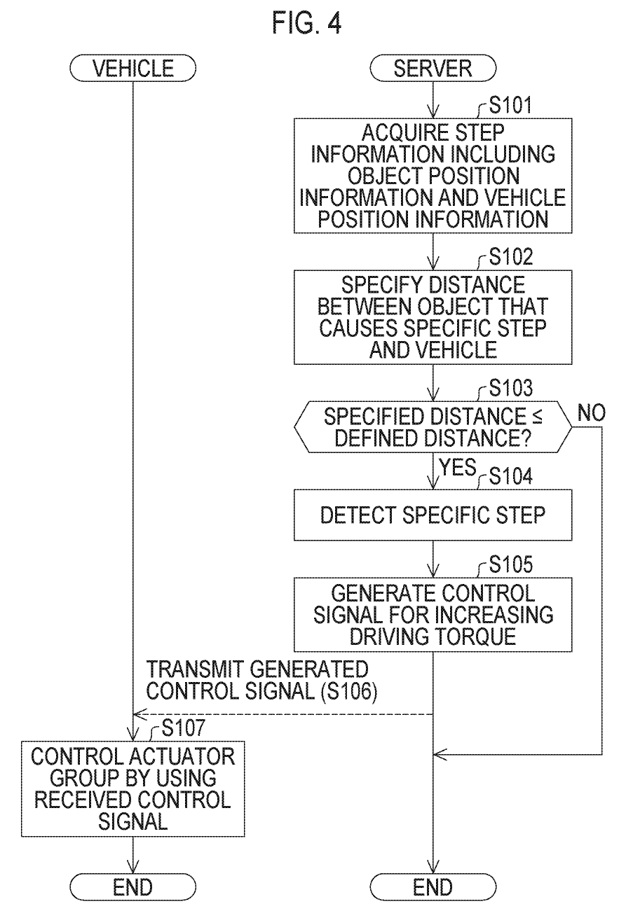

FIG. 4 is a flowchart showing the control method in the first embodiment. The flow shown in FIG. 4 is repeatedly executed, for example, at a predetermined time cycle from a point in time at which the vehicle 100 starts the unmanned driving traveling. In step S101, the acquisition unit 211 of the server 200 acquires the step information including the object position information and the vehicle position information. In step S102, the detection unit 212 of the server 200 specifies a distance between the object that causes the specific step ST and the vehicle 100 by using the object position information and the vehicle position information. In a case where the specified distance, that is, the distance between the object that causes the specific step ST and the vehicle 100 is not within a defined distance that is predetermined (step S103: No), the server 200 ends the present flow. In a case where the distance between the object that causes the specific step ST and the vehicle 100 is within the defined distance (step S103: Yes), in step S104, the detection unit 212 detects that the specific step ST is present ahead of the vehicle 100 that has traveled. In a case where the detection unit 212 detects that the specific step ST is present ahead of the vehicle 100 that has traveled, in step S105, the remote controller 213 of the server 200 generates a control signal for increasing the driving torque of the vehicle 100. In step S106, the remote controller 213 transmits the generated control signal to the vehicle 100. In step S107, the vehicle controller 115 of the vehicle 100 increases the driving torque of the vehicle 100 by controlling the actuator group 120 by using the received control signal. As a result, the vehicle 100 crosses the specific step ST.

According to the first embodiment, in a case where the detection unit 212 detects that the specific step ST is present ahead of the vehicle 100 that has traveled, the control system 50 can increase the driving torque of the vehicle 100 by the remote control. In such a form, the vehicle 100 can cross the specific step ST by the remote control.

In addition, according to the first embodiment, the control system 50 can specify the distance between the object that causes the specific step ST and the vehicle 100 by acquiring the object position information and the vehicle position information. Then, the control system 50 can detect that the specific step ST is present ahead of the vehicle 100 that has traveled according to the distance between the object that causes the specific step ST and the vehicle 100. In such a form, it is possible to detect that the vehicle 100 is approaching the specific step ST by using the fact that the position of the object that causes the specific step ST in the factory FC is known, and to increase the driving torque of the vehicle 100. As a result, the vehicle 100 can cross the specific step ST.

In addition, according to the first embodiment, the control system 50 can control the driving torque of the vehicle 100 according to the distance between the object that causes the specific step ST and the vehicle 100. In such a form, the driving torque of the vehicle 100 can be temporarily increased to cause the vehicle 100 to cross the specific step ST, and then the driving torque of the vehicle 100 can be restored to the original state before the increase. As a result, it is possible to avoid maintaining the driving torque of the vehicle 100 at an increased level after the vehicle 100 crosses the specific step ST.

In addition, according to the first embodiment, in the control system 50, the map MP representing the position of each object in the factory FC and the reference route RR are stored in the memory 202. In such a form, a coordinate on the map MP that is positioned within the defined distance from the object that causes the specific step ST can be specified in advance, and a coordinate representing a point at which the driving torque of the vehicle 100 is to be increased can be registered in advance on the map MP. As a result, in a case where the coordinate represented by the vehicle position information corresponds to the coordinate registered in advance on the map MP, the driving torque of the vehicle 100 can be increased. That is, the point at which the driving torque of the vehicle 100 is to be increased can be designated by the coordinate on the map MP.

In addition, according to the first embodiment, in a case where the maximum allowable torque is predetermined, the control system 50 may temporarily increase the maximum allowable torque or may temporarily release the restriction by the maximum allowable torque. In such a form, the driving torque of the vehicle 100 can be temporarily increased to cause the vehicle 100 to cross the specific step ST, and then the driving torque of the vehicle 100 can be restored to the original state before the increase. As a result, it is possible to avoid maintaining the driving torque of the vehicle 100 at an increased level after the vehicle 100 crosses the specific step ST.

### B. Second Embodiment

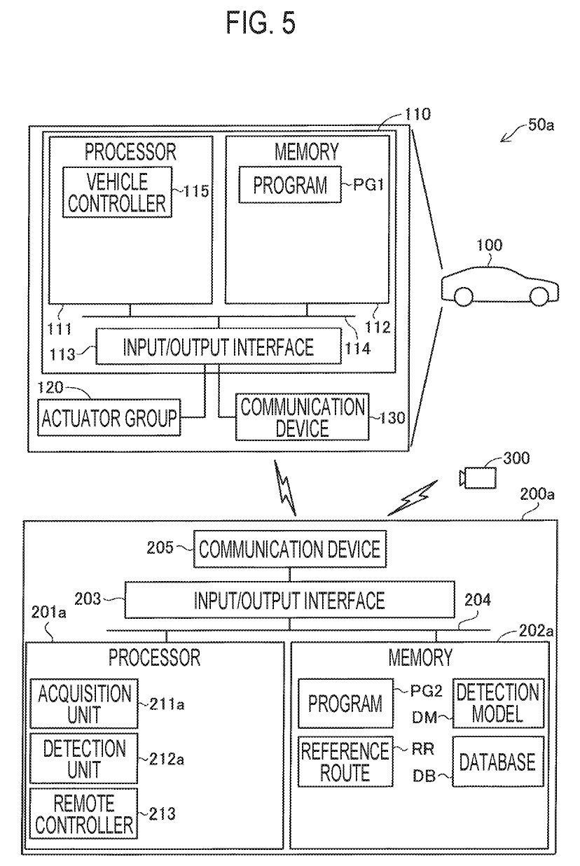

FIG. 5 is a block diagram showing a configuration of a control system 50a in the second embodiment. The control system 50a comprises one or more vehicles 100, a server 200a, and one or more external sensors 300. In the present embodiment, a processor 201a of the server 200a executes the program PG2 stored in a memory 202a to implement various functions including a function as an acquisition unit 211a, a detection unit 212a, and the remote controller 213. The acquisition unit 211a acquires the step information including the step process information and the execution process information. The step process information is information indicating a manufacturing process executed at the manufacturing places PL1, PL2, TR where the specific step ST is present. The execution process information is information indicating a manufacturing process currently being executed on the vehicle 100. The acquisition unit 211a acquires the step process information by referring to, for example, a database DB stored in advance in the memory 202a. In addition, the acquisition unit 211a acquires the execution process information by communicating with various devices such as manufacturing equipment (not shown) or the inspection equipment 900 installed at the manufacturing places PL1, PL2, and the external sensor 300. The detection unit 212a detects that the specific step ST is present ahead of the vehicle 100 that has traveled in a case where the manufacturing process specified by the execution process information matches the manufacturing process specified by the step process information. The function of the remote controller 213 is the same as that in the first embodiment. The same configurations as those of the first embodiment will be designated by the same reference numerals and will not be described.

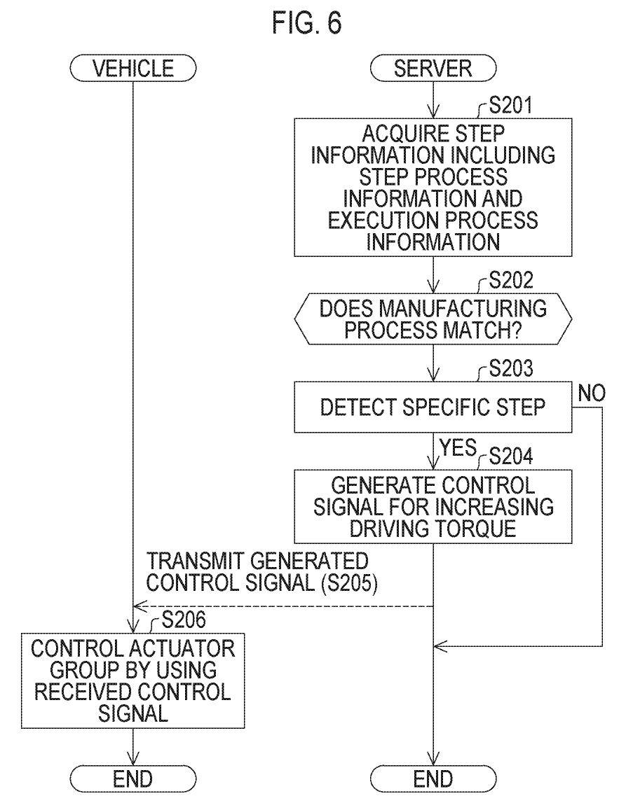

FIG. 6 is a flowchart showing the control method in the second embodiment. The flow shown in FIG. 6 is repeatedly executed, for example, at a predetermined time cycle from a point in time at which the vehicle 100 starts the unmanned driving traveling. In step S201, the acquisition unit 211a of the server 200a acquires the step information including the step process information and the execution process information. In a case where the manufacturing process specified by the execution process information does not match the manufacturing process specified by the step process information (step S202: No), the server 200a ends the present flow. In a case where the manufacturing process specified by the execution process information matches the manufacturing process specified by the step process information (step S202: Yes), the process proceeds to step S203. In step S203, the detection unit 212a of the server 200a detects that the specific step ST is present ahead of the vehicle 100 that has traveled. In a case where the detection unit 212a detects that the specific step ST is present ahead of the vehicle 100 that has traveled, in step S204, the remote controller 213 of the server 200a generates a control signal for increasing the driving torque of the vehicle 100. In step S205, the remote controller 213 transmits the generated control signal to the vehicle 100. In step S206, the vehicle controller 115 of the vehicle 100 increases the driving torque of the vehicle 100 by controlling the actuator group 120 by using the received control signal. As a result, the vehicle 100 crosses the specific step ST.

According to the second embodiment, the control system 50a can detect that the specific step ST is present ahead of the vehicle 100 that has traveled according to the manufacturing process executed on the vehicle 100. In such a form, it is possible to detect that the vehicle 100 is approaching the specific step ST by using the fact that the manufacturing process in which the object that causes the specific step ST is present in the factory FC is known, and to increase the driving torque of the vehicle 100. As a result, the vehicle 100 can cross the specific step ST.

### C. Third Embodiment

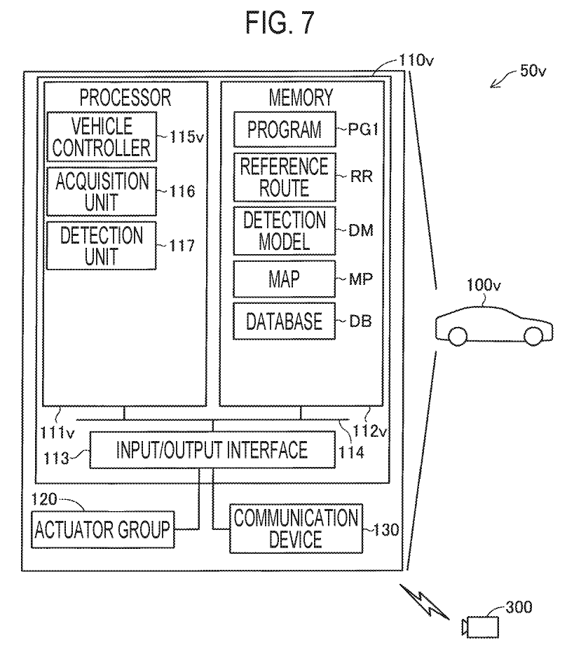

FIG. 7 is a descriptive view showing a schematic configuration of a control system 50v according to a third embodiment. In the present embodiment, the control system 50v is different from that in the first embodiment in that the server 200 is not provided. In addition, a vehicle 100v according to the present embodiment can travel via the autonomous control of the vehicle 100v. Other configurations are the same as the configurations of the first embodiment unless otherwise described.

In the present embodiment, a processor 111v of a vehicle control device 110v functions as a vehicle controller 115v, an acquisition unit 116, and a detection unit 117 by executing the program PG1 stored in a memory 112v. The acquisition unit 116 acquires various types of information including the step information. The detection unit 117 detects that the specific step ST is present ahead of the vehicle 100v that has traveled by using the step information. The vehicle controller 115v can acquire the output result of the sensor, generate the traveling control signal by using the output result, and output the generated traveling control signal to operate the actuator group 120, thereby causing the vehicle 100v to travel via the autonomous control. In the present embodiment, the detection model DM or the reference route RR is stored in advance in the memory 112v in addition to the program PG1. During the period in which the autonomous control is executed, the detection unit 117 may detect that the specific step ST is present ahead of the vehicle 100v that has traveled. In such a case, the vehicle controller 115v increases the driving torque of the vehicle 100v to a degree at which the vehicle 100v can cross the specific step ST.

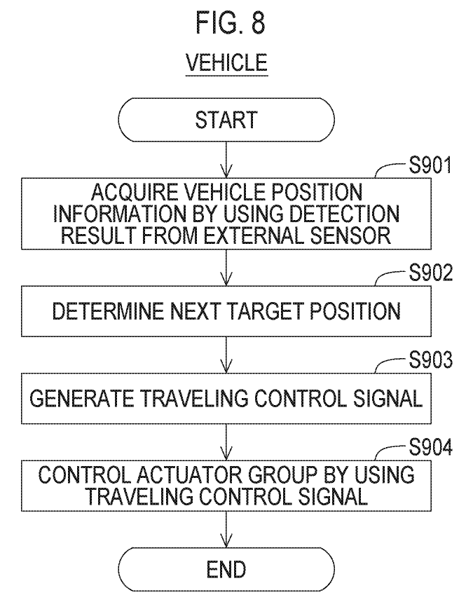

FIG. 8 is a flowchart showing a processing procedure of traveling control of the vehicle 100v according to the third embodiment. In the processing procedure of FIG. 8, the processor 111v of the vehicle 100v executes the program PG1 to function as the vehicle controller 115v.

In step S901, the processor 111v of the vehicle control device 110v acquires the vehicle position information by using the detection result output from the camera that is the external sensor 300. In step S902, the processor 111v determines a target position to which the vehicle 100v is to travel next. In step S903, the processor 111v generates the traveling control signal for causing the vehicle 100v to travel toward the decided target position. In step S904, the processor 111v controls the actuator group 120 by using the generated traveling control signal, to cause the vehicle 100v to travel in accordance with the parameters represented by the traveling control signal. The processor 111v repeatedly executes, at a predetermined cycle, the acquisition of the vehicle position information, the decision of the target position, the generation of the traveling control signal, and the control of the actuator. With the control system 50v according to the present embodiment, the vehicle 100v can be caused to travel via the autonomous control of the vehicle 100v without the need for the server 200 to remotely control the vehicle 100v.

According to the third embodiment, in a case where the detection unit 117 detects that the specific step ST is present ahead of the vehicle 100 that has traveled, the control system 50v can increase the driving torque of the vehicle 100v by the autonomous control of the vehicle 100v. In such a form, the vehicle 100v can cross the specific step ST by the autonomous control of the vehicle 100v.

### D. Other Embodiments

(D1) There is a correlation between the driving torque and the acceleration of the vehicle 100. Therefore, the expression “driving torque” in the present disclosure can be appropriately replaced with “acceleration”. That is, in a case where the detection unit 117, 212, 212a detect that the specific step ST is present ahead of the vehicle 100, 100v that has traveled, the controller 115v, 213 may increase the acceleration of the vehicle 100, 100v to a degree at which the vehicle 100, 100v can cross the specific step ST. In this case, the controller 115v, 213 sets, for example, the acceleration included as the parameter in the traveling control signal to be larger than the traveling control signal transmitted last time. Even in such a form, the vehicle 100, 100v can cross the specific step ST. In a case where the detection unit 117, 212, 212a detects that the specific step ST is present ahead of the vehicle 100, 100v that has traveled, the maximum allowable acceleration may be predetermined. In such a case, the controller 115v, 213 may temporarily increase the maximum allowable acceleration or may temporarily release the restriction by the maximum allowable acceleration. The maximum allowable acceleration is a maximum value of the allowable acceleration. In such a form, the acceleration of the vehicle 100, 100v can be temporarily increased to cause the vehicle 100, 100v to cross the specific step ST, and then the acceleration of the vehicle 100, 100v can be restored to the original state before the increase. As a result, it is possible to avoid the vehicle 100, 100v from continuing to accelerate after the vehicle 100, 100v crosses the specific step ST.

(D2) The acquisition unit 116, 211, 211a may further acquire information related to a size of the specific step ST, such as a height and a width. In this case, the controller 115v, 213 may determine the amount of increase in the driving torque according to the size of the specific step ST. For example, the controller 115v, 213 may determine the amount of increase in the driving torque to be larger as the height of the specific step ST, that is, the height difference between the object that causes the specific step ST and the road surface is larger. In such a form, the amount of increase in the driving torque can be determined according to the size of the specific step ST. As a result, the vehicle 100, 100v can more reliably cross the specific step ST. In addition, it is possible to prevent the driving torque of the vehicle 100, 100v from being increased more than necessary and the vehicle 100, 100v from being accelerated more than necessary in a case where the vehicle 100, 100v crosses the specific step ST.

(D3) The acquisition unit 116, 211, 211a may further acquire information related to a shape of the specific step ST. In this case, the controller 115v, 213 may determine the amount of increase in the driving torque according to the shape of the specific step ST. In such a form, the amount of increase in the driving torque can be determined according to the shape of the specific step ST. As a result, the vehicle 100, 100v can more reliably cross the specific step ST. In addition, it is possible to prevent the driving torque of the vehicle 100, 100v from being increased more than necessary and the vehicle 100, 100v from being accelerated more than necessary in a case where the vehicle 100, 100v crosses the specific step ST.

(D4) The acquisition unit 116, 211, 211a may further acquire information related to the surrounding environment of the vehicle 100, 100v. In this case, the controller 115v, 213 may determine the amount of increase in the driving torque according to the surrounding environment of the vehicle 100, 100v. For example, the controller 115v,213 may determine the amount of increase in the driving torque to be smaller as the frequency of movement of other moving objects such as a worker is higher. In such a form, the amount of increase in the driving torque can be determined according to the surrounding environment of the vehicle 100, 100v. As a result, it is possible to prevent a problem such as the vehicle 100, 100v coming into contact with another moving object in a case where the vehicle 100, 100v crosses the specific step ST.

(D5) The control systems 50, 50a, 50v may be used outside the factory FC that manufactures the vehicle 100, 100v. That is, the control systems 50, 50a, 50v may control the vehicle 100, 100v after shipment. In a case where the control systems 50, 50a, 50v are used outside the factory FC, the expression “manufacturing” in the present disclosure can be appropriately replaced with “work”. In such a form, the vehicle 100, 100v can cross the specific step ST even at a workplace other than the factory FC, such as a city or an inspection field.

(D6) At least a part of the functions of the server 200, 200a may be a function of the vehicle control device 110, 110v or a function of another device such as the external sensor 300. At least a part of the functions of the vehicle control device 110, 110v may be a function of the server 200, 200a or a function of another device such as the external sensor 300. In such a form, the configurations of the control systems 50, 50a, 50v can be appropriately changed.

(D7) In each of the above-described embodiments, the external sensor 300 is not limited to the camera, and may be, for example, a distance measurement device. The distance measurement device is, for example, light detection and ranging (LiDAR). In this case, the detection result output by the external sensor 300 may be three-dimensional point cloud data representing the vehicle 100, 100v. In this case, the server 200 or the vehicle 100, 100v may acquire the vehicle position information via template matching using the three-dimensional point cloud data as the detection result, and reference point cloud data prepared in advance.

(D8) In the first embodiment and the second embodiment, the server 200, 200a executes processing from the acquisition of the vehicle position information to the generation of the traveling control signal. On the other hand, the vehicle 100 may execute at least a part of the processing from the acquisition of the vehicle position information to the generation of the traveling control signal. For example, the following forms (1) to (3) may be used.

(1) The server 200, 200a may acquire the vehicle position information, decide the target position to which the vehicle 100 should head next, and generate the route from the current position of the vehicle 100 represented by the acquired vehicle position information to the target position. The server 200, 200a may generate a route to the target position between the current position and the destination or may generate a route to the destination. The server 200, 200a may transmit the generated path to the vehicle 100. The vehicle 100 may generate the traveling control signal for causing the vehicle 100 to travel on the route received from the server 200, 200a, and control the actuator group 120 by using the generated traveling control signal.

(2) The server 200, 200a may acquire the vehicle position information and transmit the acquired vehicle position information to the vehicle 100. The vehicle 100 decides the target position to which the vehicle 100 should head next and generates the route from the current position of the vehicle 100 represented by the received vehicle position information to the target position. The vehicle 100 may generate the traveling control signal for causing the vehicle 100 to travel on the generated route, and control the actuator group 120 by using the generated traveling control signal.

(3) In each of the above-described forms (1) and (2), an internal sensor may be mounted on the vehicle 100, and a detection result output from the internal sensor may be used for at least one of the generation of the route and the generation of the traveling control signal. The internal sensor is a sensor mounted in the vehicle 100. The internal sensor may include, for example, a sensor that detects a motion state of the vehicle 100, a sensor that detects an operation state of each unit of the vehicle 100, or a sensor that detects a surrounding environment of the vehicle 100. Specifically, the internal sensor may include, for example, a camera, a LiDAR, a millimeter wave radar, an ultrasound sensor, a GPS sensor, an acceleration sensor, and a gyro sensor. For example, in the above-described form (1), the server 200, 200a may acquire the detection result of the internal sensor and reflect the detection result of the internal sensor in the route when the route is generated. In the above-described form (1), the vehicle 100 may acquire the detection result of the internal sensor and reflect the detection result of the internal sensor to the traveling control signal when the traveling control signal is generated. In the above-described form (2), the vehicle 100 may acquire the detection result of the internal sensor and reflect the detection result of the internal sensor to the route when the route is generated. In the above-described form (2), the vehicle 100 may acquire the detection result of the internal sensor and reflect the detection result of the internal sensor to the traveling control signal when the traveling control signal is generated.

(D9) In the third embodiment, an internal sensor may be mounted on the vehicle 100v, and a detection result output from the internal sensor may be used for at least one of the generation of the route and the generation of the traveling control signal. For example, the vehicle 100v may acquire the detection result of the internal sensor and reflect the detection result of the internal sensor to the route when the route is generated. The vehicle 100v may acquire the detection result of the internal sensor and reflect the detection result of the internal sensor to the traveling control signal when the traveling control signal is generated.

(D10) In the third embodiment, the vehicle 100v acquires the vehicle position information by using the detection result from the external sensor 300. On the other hand, the vehicle 100v is equipped with an internal sensor. The vehicle 100v acquires the vehicle position information by using the detection result of the internal sensor and determines the target position to which the vehicle 100v is to travel next. The vehicle 100v generates a path from the current location of the vehicle 100v represented by the acquired vehicle position information to the target position. The vehicle 100v may generate the traveling control signal for traveling on the generated path, and control the actuator group 120 by using the generated traveling control signal. In this case, the vehicle 100v can travel without using the detection result of the external sensor 300 at all. The vehicle 100v may acquire a target arrival time or traffic jam information from the outside of the vehicle 100v and reflect the target arrival time or the traffic jam information to at least one of the route and the traveling control signal. In addition, all functional configurations of the control system 50v may be provided in the vehicle 100v. That is, the processing implemented by the control system 50v according to the present disclosure may be implemented by the vehicle 100v alone.

(D11) In the first embodiment and the second embodiment, the server 200, 200a automatically generates the traveling control signal to be transmitted to the vehicle 100. On the other hand, the server 200, 200a may generate the traveling control signal to be transmitted to the vehicle 100 in response to an operation of an external operator who is located outside the vehicle 100. For example, the external operator may operate a steering wheel, an accelerator pedal, and a brake pedal for remotely operating the vehicle 100, and a display that displays the captured image output from the external sensor 300. Further, the external operator may operate a control device comprising a communication device for communicating with the server 200, 200a by wired communication or wireless communication. Then, the server 200, 200a may generate the traveling control signal in accordance with the operation applied to the control device.

(D12) In each of the above-described embodiments, the vehicle 100, 100v need solely have a configuration capable of moving under the unmanned driving, and may have, for example, a form of a platform having a configuration described below. Specifically, the vehicle 100, 100v need solely include at least the vehicle control device 110, 110v and the actuator group 120, in order to exhibit the three functions of “traveling”, “turning”, and “stopping” under the unmanned driving. In a case where the vehicle 100, 100v acquires the information from the outside for the unmanned driving, the vehicle 100, 100v needs solely further include the communication device 130. That is, the vehicle 100, 100v that can move under the unmanned driving need not be equipped with at least a part of interior components, such as a driver's seat and a dashboard. Further, the vehicle 100, 100v may not be equipped with at least a part of exterior components such as a bumper and a fender, and may not be equipped with a body shell. In this case, the remaining components such as the body shell may be mounted on the vehicle 100, 100v until the vehicle 100, 100v is shipped from the factory FC. In addition, the remaining components such as the body shell may be mounted on the vehicle 100, 100v after the vehicle 100, 100v is shipped from the factory FC in a state where the remaining components such as the body shell are not mounted on the vehicle 100, 100v. The respective components may be equipped from any direction, such as an upper side, a lower side, a front side, a rear side, a right side, or a left side of the vehicle 100, 100v, and may be equipped from the same direction or different directions. The position decision can be made for the form of the platform in the same manner as the vehicle 100, 100v according to the first embodiment.

(D13) The vehicle 100, 100v may be manufactured by combining a plurality of modules. The module means a unit configured by one or more components assembled depending on the configuration or the function of the vehicle 100, 100v. For example, the platform of the vehicle 100, 100v may be manufactured by combining a front module, a central module, and a rear module. The front module constitutes a front portion of the platform. The central module constitutes a central portion of the platform. The rear module constitutes a rear portion of the platform. In addition, the number of modules constituting the platform is not limited to three, and may be two or less or four or more. In addition to or instead of the platform, a portion of the vehicle 100, 100v that is different from the platform may be modularized. In addition, various modules may include any exterior component, such as a bumper or a grille, or any interior component, such as a seat or a console. Such a module may be manufactured, for example, by joining the components via welding, a fastener, or the like, or may be manufactured by integrally molding at least a part of the modules as one component via casting. A molding method of integrally molding at least a part of the modules as one component is also called giga casting or mega casting. By using the giga casting, each unit of the vehicle 100, 100v that has been formed by joining a plurality of components in the related art can be formed as one component. For example, the front module, the center module, and the rear module may be manufactured by using giga casting.

(D14) Transporting the vehicle 100, 100v by using the traveling of the vehicle 100, 100v under the unmanned driving is also called “self-propelled transport”. A configuration for implementing the autonomous transport is also referred to as “vehicle remote control autonomous driving transport system”. A production method of producing the vehicle 100, 100v by using the autonomous transport is also referred to as “autonomous production”. In the self-propelled production, for example, at the factory FC that manufactures the vehicle 100, 100v, at least a part of the transport of the vehicle 100, 100v is implemented by the self-propelled transport.

(D15) In each of the above-described embodiments, a part or all of the functions and the processing that are implemented by software may be implemented by hardware. Alternatively, a part or all of the functions and the processing that are implemented by hardware may be implemented by software. As the hardware for implementing various functions in each of the above-described embodiments, for example, various circuits, such as an integrated circuit or a discrete circuit, may be used.

The present disclosure is not limited to the above-described embodiments, and can be implemented with various configurations without departing from the gist of the present disclosure. For example, the technical features of the embodiments corresponding to the technical features in each form described in the section of SUMMARY can be replaced or combined as appropriate to solve some or all of the above objects, or to achieve some of or all the above effects. In a case where the technical features are not described as being always needed in the present specification, the features can be deleted as appropriate.

What is claimed is:

1. A control system for controlling a vehicle configured to travel under unmanned driving, the control system comprising:
an acquisition unit configured to acquire step information related to a specific step that is predetermined as a step to be ridden over by the vehicle among steps present on a travel route of the vehicle;
a detection unit configured to detect, using the step information, that the specific step is present ahead of the vehicle as the vehicle travels; and
a controller configured to increase driving torque of the vehicle in a case where the detection unit detects that the specific step is present ahead of the vehicle as the vehicle travels.

2. The control system according to claim 1, wherein:
the step information includes object position information indicating a position of an object that causes the specific step;
the acquisition unit is further configured to acquire vehicle position information indicating a position of the vehicle; and
the detection unit is configured to detect that the specific step is present ahead of the vehicle as the vehicle travels in a case where a distance between the object and the vehicle is within a predetermined distance, the distance being specified by using the object position information and the vehicle position information.

3. The control system according to claim 1, wherein:
the step information includes step process information indicating a work process executed at a workplace where the specific step is present;
the acquisition unit is further configured to acquire execution process information indicating the work process that is being executed on the vehicle; and
the detection unit is configured to detect that the specific step is present ahead of the vehicle as the vehicle travels in a case where the work process specified by the execution process information matches the work process specified by the step process information.

4. The control system according to claim 1, wherein:
the acquisition unit is further configured to acquire information related to a size of the specific step; and
the controller is configured to determine an amount of increase in the driving torque based on the size of the specific step.

5. The control system according to claim 1, wherein:
the acquisition unit is further configured to acquire information related to a shape of the specific step; and
the controller is configured to determine an amount of increase in the driving torque based on the shape of the specific step.
